(19) United States
(12) Patent Application Publication
(10) Pub. No.: US 2019/0064778 A1
(43) Pub. Date: Feb. 28, 2019

(54) MACHINE TOOL AND SPEED CONTROL METHOD

(71) Applicant: FANUC CORPORATION, Yamanashi (JP)

(72) Inventors: Fuminobu Nakamura, Minamitsuru-gun (JP); Masahiro Murota, Minamitsuru-gun (JP)

(73) Assignee: FANUC CORPORATION, Yamanashi (JP)

(21) Appl. No.: 16/113,458

(22) Filed: Aug. 27, 2018

(30) Foreign Application Priority Data
Aug. 28, 2017 (JP) 2017-163196

(51) Int. Cl. G05B 19/416

(52) U.S. Cl. CPC G05B 19/416; G05B 2219/35514; G05B 2219/37347

(57) ABSTRACT

A machine tool, which performs machining on a workpiece using a tool, is equipped with a servo motor configured to cause axial movement of the tool or the workpiece, an imaging device configured to capture an image of the tool or the workpiece at a specified imaging magnification, a display unit configured to display the image captured by the imaging device, a speed compensating unit configured to compensate a command speed of the tool or the workpiece on the basis of the imaging magnification and thereby generate a compensated command speed, and a motor control unit configured to control the servo motor in a manner so that the tool or the workpiece is axially moved at the compensated command speed.

### CROSS-REFERENCE TO RELATED APPLICATION

This application is based upon and claims the benefit of priority from Japanese Patent Application No. 2017-163196 filed on Aug. 28, 2017, the contents of which are incorporated herein by reference.

### BACKGROUND OF THE INVENTION

### Field of the Invention

The present invention relates to a machine tool and a speed control method for controlling a speed of axial movement.

### Description of the Related Art

Conventionally, in the field of machine tools, an imaging device has been provided in a machine tool, and the machine tool has carried out a predetermined process by analyzing images of a tool or a workpiece captured by the imaging device, and has displayed the captured images.

For example, in Japanese Laid-Open Patent Publication No. 2016-132039, it is disclosed that images of a tool mounted on a tool post are captured, and the position and shape of a cutting edge of the tool are detected on the basis of the captured images. It is also disclosed that, as necessary, zooming up is performed to acquire a normal image in which the cutting edge of the tool is located at a center in the field of view.

### SUMMARY OF THE INVENTION

In this instance, cases occur in which the operator manually performs axial movement (for example, axial movement of the tool) while observing the captured images. In a state in which the imaging magnification is low, since the speed of movement of the tool in the image becomes slow, there is a demand to increase the speed of movement of the tool in order to shorten the operation time. Conversely, in a state in which the imaging magnification is high, because the speed of movement of the tool in the image becomes too rapid, there is a concern that the operation of the operator will be delayed, and the tool may collide with the workpiece. However, such a problem cannot be solved with the technique disclosed in Japanese Laid-Open Patent Publication No. 2016-132039.

The present invention provides a machine tool and a speed control method, which are capable of shortening the operation time, and of controlling a speed of axial movement so as to be capable of avoiding a collision between a tool and a workpiece.

A first aspect of the present invention is characterized by a machine tool configured to perform machining on a workpiece using a tool, including a motor configured to cause axial movement of the tool or the workpiece, an imaging device configured to capture an image of the tool or the workpiece at a specified imaging magnification, a display unit configured to display the image captured by the imaging device, a speed compensating unit configured to compensate a command speed of the tool or the workpiece on the basis of the imaging magnification, and to thereby generate a compensated command speed, and a motor control unit configured to control the motor in a manner so that the tool or the workpiece is axially moved at the compensated command speed.

A second aspect of the present invention is characterized by a speed control method for controlling a speed of axial movement of a machine tool configured to perform machining on a workpiece using a tool, wherein the machine tool includes a motor configured to cause axial movement of the tool or the workpiece, and the speed control method includes an imaging step of capturing an image of the tool or the workpiece at a specified imaging magnification, a displaying step of displaying the captured image, a speed compensating step of compensating a command speed of the tool or the workpiece on the basis of the imaging magnification, and thereby generating a compensated command speed, and a motor controlling step of controlling the motor in a manner so that the tool or the workpiece is axially moved at the compensated command speed.

According to the present invention, it is possible to shorten the operation time, and to control the speed of axial movement so as to be capable of avoiding a collision between the tool and the workpiece.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a machine tool;

FIG. 2 is a diagram showing a configuration of a controller, servo amplifiers, servo motors, and an imaging device shown in FIG. 1;

FIG. 3 is a flowchart illustrating an image capturing operation of the machine tool shown in FIGS. 1 and 2;

FIG. 4 is a flowchart illustrating an axial feeding operation of the machine tool shown in FIGS. 1 and 2;

FIG. 5A is a view showing an image at a time that an image of an axial feed of a conventional tool is captured at low magnification;

FIG. 5B is a view showing an image at a time that an image of an axial feed of a conventional tool is captured at a medium magnification;

FIG. 5C is a view showing an image at a time that an image of an axial feed of a conventional tool is captured at high magnification;

FIG. 6A is a view showing an image at a time that an image of an axial feed of a tool according to the present embodiment is captured at a medium magnification (reference magnification);

FIG. 6B is a view showing an image at a time that an image of an axial feed of a tool according to the present embodiment is captured at high magnification; and

FIG. 6C is a view showing an image at a time that an image of an axial feed of a tool according to the present embodiment is captured at low magnification.

### DESCRIPTION OF THE PREFERRED EMBODIMENTS

Preferred embodiments of a machine tool and a speed control method according to the present invention will be presented and described in detail below with reference to the accompanying drawings.

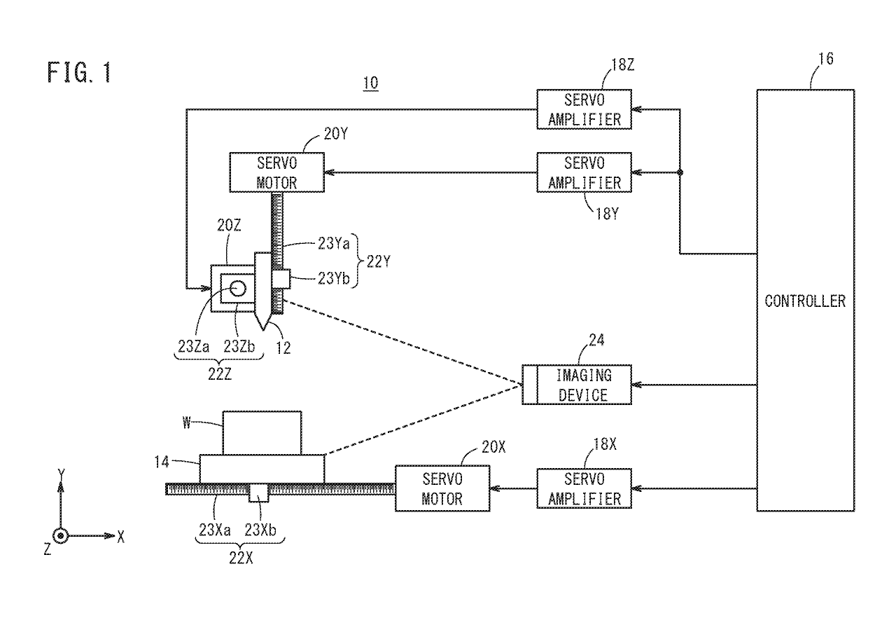

FIG. 1 is a schematic configuration diagram of a machine tool 10. The machine tool 10 is a machine tool adapted to machine a workpiece W (object to be machined) using a tool 12. The machine tool 10 is equipped with the tool 12, a table 14, a controller 16, servo amplifiers 18 (18Y, 18Z, 18X), servo motors (motors) 20 (20Y, 20Z, 20X), power conversion transmission mechanisms 22 (22Y, 22Z, 22X), and an imaging device 24.

The controller 16 rotates the servo motors 20 (20Y, 20Z, 20X) by controlling the servo amplifiers 18 (18Y, 18Z, 18X). In other words, the controller 16 controls rotation of the servo motors 20 (20Y, 20Z, 20X) through the servo amplifiers 18 (18Y, 18Z, 18X). The servo motor 20Y is a motor for the purpose of axially moving the tool 12 in a Y-axis direction, and the servo motor 20Z is a motor for the purpose of axially moving the tool 12 in a Z-axis direction. Further, the servo motor 20X is a motor for the purpose of axially moving the table 14 in an X-axis direction. Accordingly, the controller 16 controls rotation of the servo motors 20Y, 20Z, 20X through the servo amplifiers 18Y, 18Z, 18X, to thereby axially move the tool 12 in the Y-axis direction and the Z-axis direction, and axially move the table 14 that supports the workpiece W in the X-axis direction. Moreover, the X-axis, the Y-axis, and the Z-axis are assumed to be orthogonal to each other.

A rotational force of the servo motor (first servo motor, Y-axis servo motor) 20Y is transmitted to the tool 12 via the power conversion transmission mechanism 22Y. The power conversion transmission mechanism 22Y converts the rotational force of the servo motor 20Y into linear motion in the Y-axis direction. Accordingly, by rotation of the servo motor 20Y, the tool 12 is axially moved in the Y-axis direction (first direction). The power conversion transmission mechanism 22Y includes a ball screw 23Ya that extends in the Y-axis direction, and a nut 23Yb that is screw-engaged with the ball screw 23Ya. The ball screw 23Ya is connected to a rotary shaft (not shown) of the servo motor 20Y, and rotates together with the rotary shaft of the servo motor 20Y. The nut 23Yb is connected to the tool 12. Consequently, the ball screw 23Ya is rotated by the servo motor 20Y, whereby the nut 23Yb (and the tool 12) is axially moved in the Y-axis direction.

A rotational force of the servo motor (second servo motor, Z-axis servo motor) 20Z is transmitted to the tool 12 via the power conversion transmission mechanism 22Z. The power conversion transmission mechanism 22Z converts the rotational force of the servo motor 20Z into linear motion in the Z-axis direction. Accordingly, by rotation of the servo motor 20Z, the tool 12 is axially moved in the Z-axis direction (second direction). The power conversion transmission mechanism 22Z includes a ball screw 23Za that extends in the Z-axis direction, and a nut 23Zb that is screw-engaged with the ball screw 23Za. The ball screw 23Za is connected to a rotary shaft (not shown) of the servo motor 20Z, and rotates together with the rotary shaft of the servo motor 20Z. The nut 23Zb is connected to the tool 12. Consequently, the ball screw 23Za is rotated by the servo motor 20Z, whereby the nut 23Zb (and the tool 12) is axially moved in the Z-axis direction.

A rotational force of the servo motor (third servo motor, X-axis servo motor) 20X is transmitted to the table 14 via the power conversion transmission mechanism 22X. The power conversion transmission mechanism 22X converts the rotational force of the servo motor 20X into linear motion in the X-axis direction. Accordingly, by rotation of the servo motor 20X, the table 14 is axially moved in the X-axis direction (third direction). The power conversion transmission mechanism 22X includes a ball screw 23Xa that extends in the X-axis direction, and a nut 23Xb that is screw-engaged with the ball screw 23Xa. The ball screw 23Xa is connected to a rotary shaft (not shown) of the servo motor 20X, and rotates together with the rotary shaft of the servo motor 20X. The nut 23Xb is connected to the table 14. Consequently, the ball screw 23Xa is rotated by the servo motor 20X, whereby the nut 23Xb (and the table 14) is axially moved in the X-axis direction.

The imaging device 24 captures images of at least the tool 12 from a direction intersecting the plane (YZ plane) defined by the Y-axis direction and the Z-axis direction. The imaging device 24 includes a zooming function, and is capable of capturing images at an arbitrary imaging magnification M. The zooming function of the imaging device 24 may be constituted in the form of optical zooming or electronic zooming. In the present embodiment, for example, the minimum imaging magnification M of the imaging device 24 is set to 100 times, and the maximum imaging magnification M is set to 1000 times. Accordingly, the imaging device 24 is capable of capturing images of the tool 12 and the workpiece W with an imaging magnification M ranging from 100 times to 1000 times. Moreover, the imaging device 24 captures images at a predetermined frame rate, or in other words, captures a moving image. The imaging device 24 is arranged in a fixed manner by a non-illustrated support member.

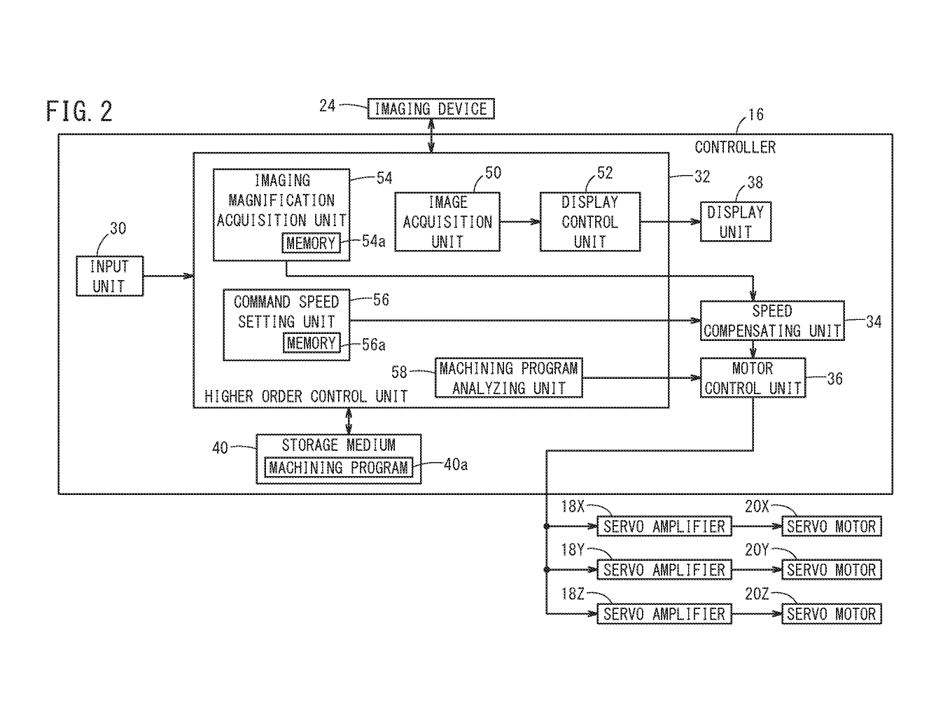

Next, with reference to FIG. 2, a brief description will be given concerning the configuration of the controller 16. The controller 16 comprises an input unit 30, a higher order control unit 32, a speed compensating unit 34, a motor control unit 36, a display unit 38, and a storage medium 40.

The input unit 30 is an operation unit by which an operator inputs a command or the like. The input unit 30 is constituted by a numeric keypad used for entering numerical data, a keyboard, a touch panel, a volume knob, and the like. According to the present embodiment, the speed of the tool 12 at a time of axial feeding, the speed of the table 14 at the time of axial feeding, and the imaging magnification M are input by the operator operating the input unit 30. In this instance, since the tool 12 is moved in two axial directions of the Y-axis direction and the Z-axis direction, the operator inputs a speed in the Y-axis direction and a speed in the Z-axis direction as the speed of the tool 12. In other words, the speed of the tool 12 includes a speed component in the Y-axis direction and a speed component in the Z-axis direction.

The higher order control unit 32 includes a processor such as a CPU, and by executing a basic program (not shown) stored in the storage medium 40, the processor functions as the higher order control unit 32 of the present embodiment. The higher order control unit 32 controls the motor control unit 36. Other details concerning the configuration of the higher order control unit 32 will be described later.

The speed compensating unit 34 compensates a command speed Vc (Vc1) of the tool 12, which is transmitted from the higher order control unit 32, and thereby generates a compensated command speed Vr (Vr1). The command speed Vc (Vc1) of the tool 12 which is compensated in this manner, i.e., the compensated command speed Vr (Vr1), is output to the motor control unit 36. Moreover, the speed compensating unit 34 outputs a command speed Vc (Vc2) of the table 14, which is transmitted from the higher order control unit 32, directly to the motor control unit 36, without performing any compensation in relation to the command speed Vc (Vc2) of the table 14. Other details concerning the speed compensating unit 34 will be described later.

In accordance with a control of the higher order control unit 32, the motor control unit 36 controls the servo motors 20 (20X, 20Y, 20Z) through the servo amplifiers 18 (18X, 18Y, 18Z). Further, in the case that an axial feeding operation of the tool 12 is performed by the operator operating the input unit 30, the motor control unit 36 controls the servo motors 20 (20Y, 20Z) through the servo amplifiers 18 (18Y, 18Z), in accordance with the compensated command speed Vr (Vr1) that was compensated by the speed compensating unit 34. Other details concerning the motor control unit 36 will be described later.

The display unit 38 is constituted by a liquid crystal display or the like, and displays necessary information to the operator. Moreover, a touch panel of the input unit 30 is provided on a display screen of the display unit 38. The storage medium 40 stores data (a basic program and the like) necessary for performing controls by the higher order control unit 32, and a machining program 40a and the like.

Next, a description will be given in detail concerning the configuration of the higher order control unit 32. The higher order control unit 32 includes an image acquisition unit 50, a display control unit 52, an imaging magnification acquisition unit 54, a command speed setting unit 56, and a machining program analyzing unit 58.

The image acquisition unit 50 acquires from the imaging device 24 the images of the tool 12 and the workpiece W (table 14) that were captured by the imaging device 24. The controller 16 and the imaging device 24 are capable of communicating wirelessly or over wires.

The display control unit 52 causes the display unit 38 to display the images (captured images) acquired by the image acquisition unit 50. Consequently, the images of the tool 12 and the workpiece W (table 14) that are captured by the imaging device 24 are displayed on the display unit 38. Moreover, the display control unit 52 may include an image processing unit that carries out image processing on the images acquired by the image acquisition unit 50, and may display the images that were subjected to image processing on the display unit 38.

The imaging magnification acquisition unit 54 is equipped with a memory 54a for storing the imaging magnification M of the imaging device 24. The imaging magnification M of the imaging device 24, which the operator has input (designated) by operating the input unit 30, is stored in the memory 54a. Consequently, the imaging magnification M stored in the memory 54a is updated. Moreover, the imaging magnification acquisition unit 54 may store the acquired imaging magnification M in the storage medium 40. In this case, the memory 54a is rendered unnecessary. Further, the imaging magnification M may also be changed on the side of the imaging device 24. In the case of being changed (designated) on the side of the imaging device 24, the imaging magnification M after having been changed is acquired from the imaging device 24 and overwritten in the memory 54a.

The command speed setting unit 56 is equipped with a memory 56a for storing the set command speeds Vc (Vc1, Vc2). The command speed setting unit 56 sets as the command speed Vc (Vc1) the speed of the tool 12 that was input by the operator in accordance with operations of the input unit 30 made by the operator, and sets as the command speed Vc (Vc2) the speed of the table 14 that was input by the operator. More specifically, the command speed setting unit 56 sets the input speeds as the command speeds Vc1, Vc2 by storing the input speeds in the memory 56a. By operating the input unit 30, the operator inputs the command speed of the tool 12 in the Y-axis direction and the command speed thereof in the Z-axis direction. Therefore, in the command speed setting unit 56, the input command speed in the Y-axis direction and the input command speed in the Z-axis direction are set as command speeds Vcy (Vc1y) and Vcz (Vc1z). More specifically, the command speeds Vc1 of the tool 12 include the command speed (first command speed) Vc1y of the tool 12 in the Y-axis direction, and the command speed (second command speed) Vc1z of the tool 12 in the Z-axis direction. Moreover, the command speed setting unit 56 may set the command speeds Vc1 (Vc1y, Vc1z), Vc2 by storing the speeds that were input in the storage medium 40. In this case, the memory 56a is rendered unnecessary.

The machining program analyzing unit 58 analyzes the machining program 40a that is stored in the storage medium 40, and outputs the analysis result to the motor control unit 36.

The speed compensating unit 34 acquires the imaging magnification M of the imaging device 24 that is stored in the memory 54a of the imaging magnification acquisition unit 54, and together therewith, acquires the command speeds Vc (Vc1, Vc2) that are stored in the memory 56a of the command speed setting unit 56. In addition, the speed compensating unit 34 compensates the command speed Vc (Vc1) of the tool 12 on the basis of the command speed Vc (Vc1) of the tool 12 and the imaging magnification M, and thereby generates the compensated command speed Vr (Vr1). More specifically, the speed compensating unit 34 generates a compensated command speed Vry (Vr1y) of the tool 12 in the Y-axis direction on the basis of the command speed Vc1y and the imaging magnification M, and generates a compensated command speed Vrz (Vr1z) of the tool 12 in the Z-axis direction on the basis of the command speed Vc1z and the imaging magnification M. In other words, the compensated command speeds Vr1 of the tool 12 include the compensated command speed (first compensated command speed) Vr1y of the tool 12 in the Y-axis direction, and the compensated command speed (second compensated command speed) Vr1z of the tool 12 in the Z-axis direction. The speed compensating unit 34 outputs the generated compensated command speeds Vr1 (Vr1y, Vr1z) to the motor control unit 36.

Moreover, the speed compensating unit 34 outputs the acquired command speed Vc2 of the table 14 directly to the motor control unit 36, without performing any compensation in relation to the command speed Vc2. Further, when the imaging magnification M of the imaging device 24 is the reference magnification Mm, the command speeds Vc1 of the tool 12 are not compensated, and the acquired command speeds Vc1 are output directly to the motor control unit 36. The reference magnification Mm is a predetermined imaging magnification (including an imaging magnification designated arbitrarily by the operator).

The motor control unit 36 controls the servo motors 20Y, 20Z, 20X through the servo amplifiers 18Y, 18Z, 18X. In the case that machining of the workpiece W is carried out using the machining program 40a, the motor control unit 36 controls the servo motors 20Y, 20Z, 20X on the basis of the analysis result of the machining program 40a. Consequently, the tool 12 is axially moved in the Y-axis direction and the Z-axis direction, the table 14 is axially moved in the X-axis direction, and the workpiece W is machined by the tool 12.

In the case that an axial feeding operation of the tool 12 is performed by the operator operating the input unit 30, the motor control unit 36 controls the servo motors 20Y, 20Z, on the basis of the compensated command speeds Vr1 (Vr1y, Vr1z) that were generated by the speed compensating unit 34. More specifically, when an axial feeding operation of the tool 12 in the Y-axis direction is performed by the operator, the motor control unit 36 controls the servo motor 20Y so as to move the tool 12 axially in the Y-axis direction at the compensated command speed Vr1y. Further, when an axial feeding operation of the tool 12 in the Z-axis direction is performed by the operator, the motor control unit 36 controls the servo motor 20Z so as to move the tool 12 axially in the Z-axis direction at the compensated command speed Vr1z. Moreover, when the imaging magnification M of the imaging device 24 is the reference magnification Mm, the motor control unit 36 controls the servo motors 20Y, 20Z on the basis of the command speeds Vc1 (Vc1y, Vc1z).

In the case that an axial feeding operation of the table 14 is performed by the operator, the motor control unit 36 controls the servo motor 20X so as to move the table 14 axially in the X-axis direction at the command speed Vc2. The motor control unit 36 controls the servo motors 20Y, 20Z, 20X only while axial feeding operations are being performed by the operator.

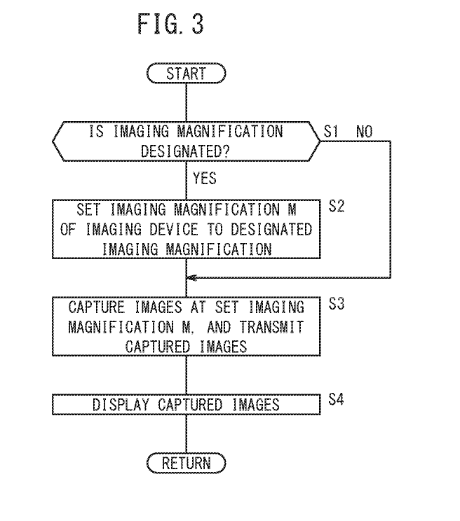

FIG. 3 is a flowchart illustrating an image capturing operation of the machine tool 10 of the present embodiment. In step S1, the imaging magnification acquisition unit 54 determines whether the imaging magnification M of the imaging device 24 has been designated (input) by the operator having operated the input unit 30. If it is determined in step S1 that the imaging magnification M has been designated, the process proceeds to step S2. At this time, the imaging magnification acquisition unit 54 overwrites the designated imaging magnification M in the memory 54a, and transmits the designated imaging magnification M to the imaging device 24. On the other hand, if it is determined in step S1 that the imaging magnification M has not been designated, the process proceeds to step S3.

Upon proceeding to step S2, the imaging device 24 sets the imaging magnification M of the imaging device 24 to the imaging magnification M that was transmitted from the imaging magnification acquisition unit 54, whereupon the process proceeds to step S3. On the basis of the set imaging magnification M, the imaging device 24 causes the angle of view to change (undergo optical zooming) by driving a zoom lens (not shown), or causes the angle of view to change (undergo electronic zooming) by changing the range of the image to be cropped (subjected to trimming).

Upon proceeding to step S3, the imaging device 24 captures images of at least the tool 12 at the set imaging magnification M. According to the present embodiment, the imaging device 24 is capable of capturing images of the tool 12 and the workpiece W (table 14) at the set imaging magnification M. In addition, the imaging device 24 transmits the images to the image acquisition unit 50. Next, in step S4, the display control unit 52 causes the display unit 38 to display thereon the images acquired by the image acquisition unit 50 from the imaging device 24.

According to the operations illustrated in FIG. 3, the imaging magnification M of the imaging device 24 is changed on the side of the controller 16, however, the imaging magnification M may also be changed on the side of the imaging device 24. In this case, in step S1, the imaging device 24 determines that the imaging magnification M has been specified in the event that a zooming operation is carried out by the operator, in accordance with an operation of an operation unit of the imaging device 24. In addition, in step S2, the imaging device 24 sets the imaging magnification M in accordance with the zooming operation. At this time, the imaging device 24 transmits the set imaging magnification M to the imaging magnification acquisition unit 54, and the imaging magnification acquisition unit 54 overwrites the imaging magnification M that was transmitted from the imaging device 24, in the memory 54a. Further, a display unit that differs from the display unit 38 may be provided on the imaging device 24, and the imaging device 24 may display the captured images on such a separate display unit. In this case, there is no need for the imaging device 24 to transmit the captured images to the image acquisition unit 50.

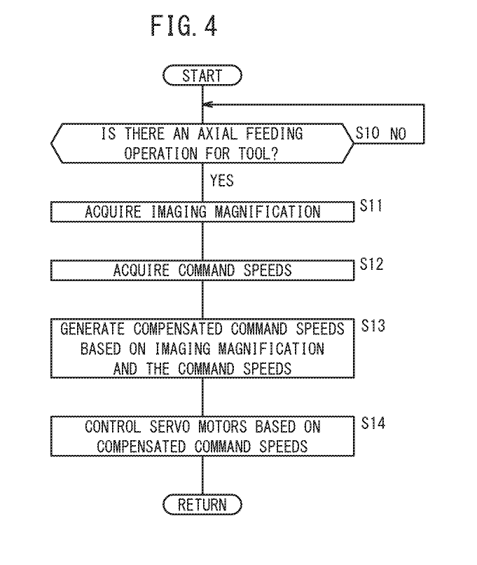

FIG. 4 is a flowchart illustrating an axial feeding operation of the machine tool 10 of the present embodiment. In FIG. 4, a description will be made concerning only the axial feeding operation of the tool 12.

In step S10, the higher order control unit 32 determines whether or not an axial feeding operation for the tool 12 has been performed in accordance with an operation of the input unit 30 by the operator. In step S10, if the higher order control unit 32 determines that an axial feeding operation of the tool 12 is not being performed, the process remains at step S10. Moreover, in the description of FIG. 4, the description is made assuming that a Y-axis axial feeding operation and a Z-axis axial feeding operation of the tool 12 are carried out simultaneously by the operator.

On the other hand, if it is determined in step S10 that an axial feeding operation has been performed by the operator, the speed compensating unit 34 acquires the imaging magnification M that is stored in the memory 54a of the imaging magnification acquisition unit 54 (step S11), together with acquiring the command speeds Vc1 (Vc1y, Vc1z) of the tool 12 that are stored in the memory 56a of the command speed setting unit 56 (step S12).

Next, in step S13, the speed compensating unit 34 compensates the command speeds Vc1 (Vc1y, Vc1z) of the tool 12 on the basis of the command speeds Vc1 (Vc1y, Vc1z) of the tool 12 and the imaging magnification M, and thereby generates the compensated command speeds Vr1 (Vr1y, Vr1z) of the tool 12. More specifically, the speed compensating unit 34 generates the compensated command speed Vr1y on the basis of the command speed Vc1y of the tool 12 in the Y-axis direction and the imaging magnification M, and generates the compensated command speed Vr1z on the basis of the command speed Vc1z of the tool 12 in the Z-axis direction and the imaging magnification M. The speed compensating unit 34 outputs the generated compensated command speeds Vr1 (Vr1y, Vr1z) to the motor control unit 36. Moreover, when the imaging magnification of the imaging device 24 is the reference magnification Mm, the speed compensating unit 34 does not compensate the command speeds Vc1 of the tool 12, and directly outputs the acquired command speeds Vc1 (Vc1y, Vc1z) to the motor control unit 36.

According to the present embodiment, in the case that the imaging magnification M acquired from the imaging magnification acquisition unit 54 is larger than the predetermined reference magnification Mm (in the case of high magnification), the speed compensating unit 34 generates compensated command speeds Vr1 (Vr1y, Vr1z) that are slower than the command speeds Vc1 (Vc1y, Vc1z). Further, in the case that the imaging magnification M is smaller than the predetermined reference magnification Mm (in the case of low magnification), the speed compensating unit 34 generates compensated command speeds Vr1 (Vr1y, Vr1z) that are faster than the command speeds Vc1 (Vc1y, Vc1z).

As the imaging magnification M becomes higher, the apparent speed of axial movement (hereinafter referred to as a movement speed) of the tool 12 displayed in the images becomes faster. However, by generating the compensated command speeds Vr1, it is possible to bring the movement speed of the tool 12 displayed in the images closer to the movement speed of the tool 12 in the images at the time of the reference magnification Mm. Conversely, as the imaging magnification M becomes lower, the apparent movement speed of the tool 12 displayed in the images becomes slower. However, by generating the compensated command speeds Vr1, it is possible to bring the movement speed of the tool 12 displayed in the images closer to the movement speed of the tool 12 in the images at the time of the reference magnification Mm. In this manner, since the command speeds Vc1 (Vc1y, Vc1z) are compensated with reference to the reference magnification Mm, the command speeds Vc1 (Vc1y, Vc1z) become the same as the command speeds at the time that the imaging magnification M is the reference magnification Mm.

The speed compensating unit 34 preferably generates the compensated command speeds Vr1 from the command speeds Vc1, on the basis of the reciprocal of the ratio of the imaging magnification M to the reference magnification Mm. In other words, preferably, the speed compensating unit 34 generates the compensated command speeds Vr1 (Vr1y, Vr1z) by multiplying the command speeds Vc1 (Vc1y, Vc1z) by the reciprocal of the ratio of the imaging magnification M to the reference magnification Mm. In this case, the compensated command speeds Vr1y, Vr1z and the command speeds Vc1y, Vc1z satisfy the following relationships (1) and (2). It should be noted that (Mm/M) is the reciprocal of the ratio (M/Mm) of the imaging magnification M to the reference magnification Mm.

Vr1y=Vc1y×(Mm/M) (1)

Vr1z=Vc1z×(Mm/M) (2)

In this manner, by generating the compensated command speeds Vr1 from the command speeds Vc1, and on the basis of the reciprocal of the ratio between the imaging magnification M and the reference magnification Mm, even if the imaging magnification M changes, the apparent movement speed of the tool 12 displayed in the images remains constant. Thus, according to the present embodiment, the compensated command speeds Vr1 are generated by multiplying the command speeds Vc1 by the reciprocal of the ratio of the imaging magnification M to the reference magnification Mm.

Next, in step S14, the motor control unit 36 controls the servo motors 20Y, 20Z through the servo amplifiers 18Y, 18Z, on the basis of the compensated command speeds Vr1 (Vr1y, Vr1z) for the tool 12 which were generated by the speed compensating unit 34.

In this manner, the compensated command speeds Vr1 are generated by compensating the command speeds Vc1 for the tool 12 using the imaging magnification M and the reference magnification Mm of the imaging device 24, which are input by operations of the input unit 30 made by the operator, and the servo motors 20Y, 20Z are controlled so as to axially feed the tool 12 at the compensated command speeds Vr1. Consequently, the tool 12 can be axially fed at an appropriate movement speed corresponding to the imaging magnification M of the imaging device 24. Therefore, the apparent movement speed of the tool 12, which is displayed on the display unit 38 in accordance with the imaging magnification M, is neither too fast nor too slow. Accordingly, it is possible to shorten the operation time, together with avoiding collisions between the tool 12 and the workpiece W.

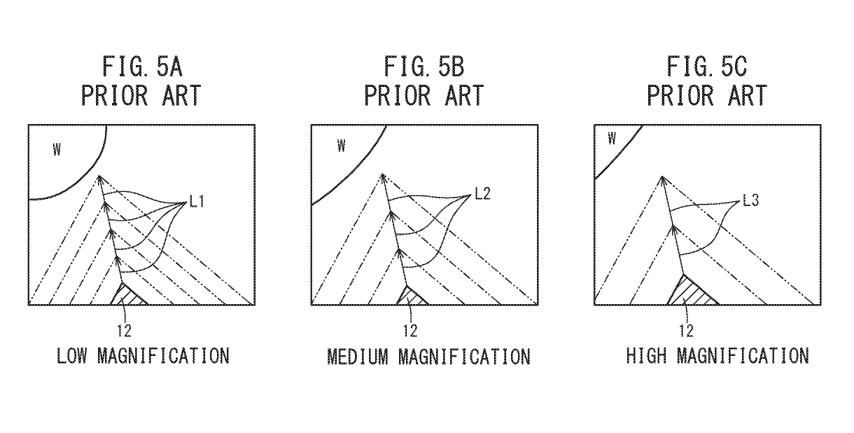

FIGS. 5A to 5C are views showing images (moving images) captured when the tool 12 (a cutting edge of the tool 12) is axially fed toward the workpiece W by a conventional axial feeding operation of the tool 12. FIG. 5A is a view showing an image at a time that an image of the axial feed of the tool 12 is captured at low magnification (N), FIG. 5B is a view showing an image at a time that an image of the axial feed of the tool 12 is captured at medium magnification (N×α), and FIG. 5C is a view showing an image at a time that an image of the axial feed of the tool 12 is captured at high magnification (N×β). It is assumed that 1<α<β, and the command speeds Vc1 of the tool 12 in FIGS. 5A to 5C are the same.

In FIG. 5A, assuming that the distance by which the tool 12 moves in the image per constant time interval T is L1, the movement speed V1 at which the tool 12 moves in the image shown in FIG. 5A is given by V1=L1/T. From the fact that the image shown in FIG. 5B is captured at an image magnification M that is α times that of the image shown in FIG. 5A, in the image shown in FIG. 5B, the distance L2 by which the tool 12 moves per constant time interval T is given by L2=L1×α. Accordingly, the movement speed V2 of the tool 12 in the image shown in FIG. 5B is given by V2=L2/T=(L1×α)/T=V1×α. Further, from the fact that the image shown in FIG. 5C is captured at an image magnification M that is β times that of the image shown in FIG. 5A, in the image shown in FIG. 5C, the distance L3 by which the tool 12 moves per constant time interval T is given by L3=L1×β. Accordingly, the movement speed V3 of the tool 12 in the image shown in FIG. 5C is given by V3=L3/T=(L1×β/T=V1×β. Moreover, since α and β satisfy the relationship of 1<α<β, L1 through L3 satisfy the relationship of L1<L2<L3, and V1 through V3 satisfy the relationship of V1<V2<V3.

In this manner, as the imaging magnification M becomes larger, the apparent movement speed of the tool 12 in the image increases, and therefore, in a state in which the imaging magnification M is a high magnification, a concern arises that the operator may not be able to keep up with the movement speed of the tool 12 displayed in the image, that the operations of the operator may be delayed, and that the tool 12 and the workpiece W may collide with each other. Further, in a state in which the imaging magnification M is a low magnification, because the movement speed of the tool 12 displayed in the image becomes too slow, the time required for the axial feeding operation is prolonged.

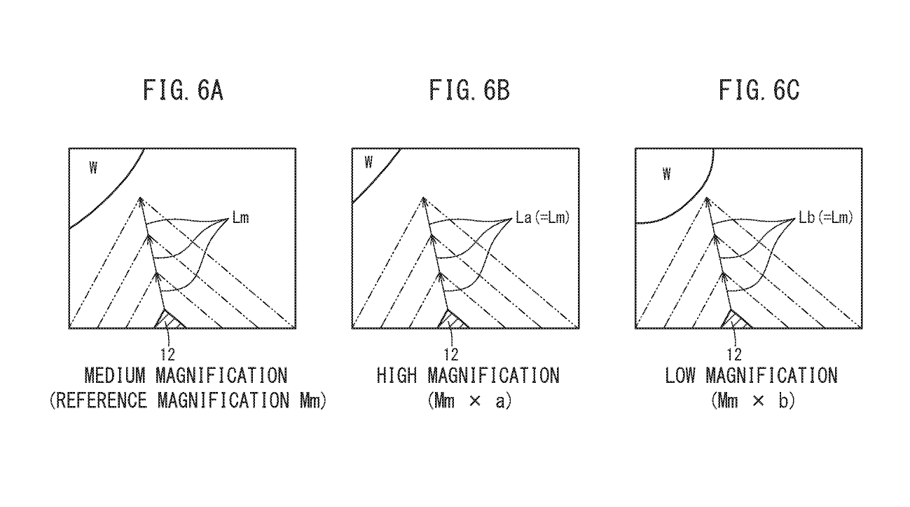

FIGS. 6A to 6C are views showing images (moving images) captured when the tool 12 (a cutting edge of the tool 12) is axially fed toward the workpiece W by an axial feeding operation of the tool 12 according to the present embodiment. FIG. 6A is a view showing an image at a time that an image of the axial feed of the tool 12 is captured at a medium magnification, i.e., the reference magnification Mm, FIG. 6B is a view showing an image at a time that an image of the axial feed of the tool 12 is captured at high magnification (Mm×a), and FIG. 6C is a view showing an image at a time that an image of the axial feed of the tool 12 is captured at low magnification (Mm×b). It is assumed that b<1<a, and the command speeds Vc1 of the tool 12 in FIGS. 6A to 6C are the same.

The image shown in FIG. 6A is captured at the reference magnification Mm, and in the present embodiment, when the imaging magnification is the reference magnification Mm, since the command speeds Vc1 of the tool 12 are not compensated, in the image shown in FIG. 6A, the movement speed Vm of the tool 12 becomes a speed corresponding to the command speeds Vc1. In FIG. 6A, assuming that the distance by which the tool 12 moves in the image per constant time interval T is Lm, the movement speed Vm at which the tool 12 moves in the image shown in FIG. 6A is given by Vm=Lm/T.

From the fact that the image shown in FIG. 6B is captured at high magnification (Mm×a), according to the present embodiment, the compensated command speeds Vr1 are generated by multiplying the command speeds Vc1 by the reciprocal of the ratio of the imaging magnification (Mm×a) to the reference magnification (Mm), i.e., 1/a. Therefore, the movement speed Va of the tool 12 in the image shown in FIG. 6B becomes a speed corresponding to the compensated command speeds Vr1, that is, Va=Vm×(1/a)×a=Vm, and is equivalent to the movement speed Vm of the tool 12 in the image shown in FIG. 6A. Accordingly, in the image shown in FIG. 6B, the distance La by which the tool 12 moves per constant time interval T becomes La=Vm×T=(Lm/T)×T=Lm, and is equivalent to the distance Lm by which the tool 12 moves per constant time interval T in the image shown in FIG. 6A.

From the fact that the image shown in FIG. 6C is captured at low magnification (Mm×b), according to the present embodiment, the compensated command speeds Vr1 are generated by multiplying the command speeds Vc1 by the reciprocal of the ratio between the imaging magnification (Mm×b) and the reference magnification (Mm), i.e., 1/b. Therefore, the movement speed Vb of the tool 12 in the image shown in FIG. 6C becomes a speed corresponding to the compensated command speeds Vr1, that is, Vb=Vm×(1/b)×b=Vm, and is equivalent to the movement speed Vm of the tool 12 in the image shown in FIG. 6A. Accordingly, in the image shown in FIG. 6C, the distance Lb by which the tool 12 moves per constant time interval T becomes Lb=Vm×T=(Lm/T)×T=Lm, and is equivalent to the distance Lm by which the tool 12 moves per constant time interval T in the image shown in FIG. 6A.

In this manner, according to the present embodiment, the compensated command speeds Vr1 are generated from the command speeds Vc1 for the tool 12, on the basis of the reciprocal of the ratio of the imaging magnification M to the reference magnification Mm. Consequently, it is possible to make the apparent movement speed of the tool 12 that is displayed on the display unit 38 equivalent to the apparent movement speed of the tool 12 at the time of the reference magnification Mm. Accordingly, even if the imaging magnification M is set (changed) to a high magnification or a low magnification, the apparent movement speed of the tool 12 in the images can be kept constant. Therefore, the apparent movement speed of the tool 12, which is displayed on the display unit 38 in accordance with the imaging magnification M, is neither too fast nor too slow. As a result, it is possible to shorten the operation time, together with avoiding collisions between the tool 12 and the workpiece W.

### MODIFICATIONS

The above-described embodiment can also be modified in the following ways.

(Modification 1) In the above-described present embodiment, the imaging device 24 is configured so as to capture images of a state of axial movement of the tool 12. However, the imaging device 24 may be arranged in a manner so as to be capable of capturing images of a state of axial movement of the table 14 (workpiece W). In this case, the speed compensating unit 34 generates a compensated command speed Vr (Vr2) on the basis of the command speed Vc2 and the imaging magnification M, and the motor control unit 36 causes the table 14 (workpiece W) to be axially moved at the compensated command speed Vr2. The imaging device 24 preferably is installed at a position which enables capturing of images of the table 14 (workpiece W) from a direction that intersects (and more preferably, is perpendicular to) the movement direction (X-axis direction) of the table 14.

(Modification 2) In the above-described embodiment, the table 14 (workpiece W) is axially moved in the X-axis direction. However, the table 14 (workpiece W) may be axially moved on a plane (for example, on the XY plane, on the XZ plane, or the like). In this case, in the event it is desired to capture images of the state of axial movement of the table 14 (workpiece W), the imaging device 24 may be installed so as to enable capturing of images from a direction that intersects (and more particularly, is perpendicular to) the plane in which the table 14 axially moves.

(Modification 3) In the above-described embodiment, a case has been presented in which speeds are controlled when axial feeding takes place among the axial movements. However, the principles of the present invention may be applied to axial movements other than axial feeding.

(Modification 4) In the above-described embodiment, the reference magnification Mm is a medium magnification. However, the reference magnification Mm is not limited to this feature, and the reference magnification Mm may be set and changed appropriately.

(Modification 5) The above-described modifications 1 to 4 may be arbitrarily combined within a range in which no inconsistencies occur.

In the foregoing manner, as was described in the above-described embodiment and in modifications 1 through 5, the machine tool 10, which performs machining on the workpiece W using the tool 12, is equipped with the servo motor 20 configured to cause axial movement of the tool 12 or the workpiece W, the imaging device 24 configured to capture an image of the tool 12 or the workpiece W at a specified imaging magnification M, the display unit 38 configured to display the image captured by the imaging device 24, the speed compensating unit 34 configured to compensate the command speed Vc for the tool 12 or the workpiece W on the basis of the imaging magnification M, and thereby generate the compensated command speeds Vr, and the motor control unit 36 configured to control the servo motors 20 in a manner so that the tool 12 or the workpiece W is axially moved at the compensated command speed Vr.

In this manner, the compensated command speeds Vr are generated on the basis of the imaging magnification M of the imaging device 24, and the servo motors 20 are controlled so that the tool 12 or the workpiece W is axially moved at the compensated command speeds Vr, and therefore, it is possible to axially move the tool 12 or the workpiece W at an appropriate movement speed in accordance with the imaging magnification M of the imaging device 24. Consequently, the axial movement of the tool 12 or the workpiece W, which is displayed on the display unit 38, is neither too fast nor too slow. Accordingly, it is possible to shorten the operation time, together with avoiding collisions between the tool 12 and the workpiece W.

The command speed Vc is a command speed at a time that the imaging magnification M is the predetermined reference magnification Mm, and the speed compensating unit 34 compensates the command speed Vc on the basis of the imaging magnification M and the reference magnification Mm. Consequently, it is possible to axially move the tool 12 or the workpiece W at a speed taking into consideration any changes in the imaging magnification M with respect to the reference magnification Mm.

In the case that the imaging magnification M is larger than the reference magnification Mm, the speed compensating unit 34 generates compensated command speed Vr that is slower than the command speed Vc, and in the case that the imaging magnification M is smaller than the reference magnification Mm, the speed compensating unit 34 generates compensated command speed Vr that is faster than the command speed Vc. Consequently, the apparent movement speed displayed on the display unit 38 can be brought closer to the apparent movement speed at the time of the reference magnification Mm.

The speed compensating unit 34 generates the compensated command speed Vr by multiplying the command speed Vc by the reciprocal of the ratio of the imaging magnification M to the reference magnification Mm. Consequently, it is possible for the apparent movement speed displayed on the display unit 38 to be made equal to the apparent movement speed at the reference magnification Mm.

The command speed Vc is a command speed at the time of axially feeding the tool 12 or the workpiece W, and the motor control unit 36 controls the servo motor 20 in a manner so that the tool 12 or the workpiece W is axially fed at the compensated command speed Vr during the time of axially feeding the tool 12 or the workpiece W. Consequently, the tool 12 or the workpiece W can be axially fed with an optimum movement speed in accordance with the imaging magnification M of the imaging device 24 at the time that the tool 12 or the workpiece W is axially fed.

The tool 12 or the workpiece W moves axially along a plane, and the servo motor 20 comprises the servo motor 20Y configured to cause the tool 12 or the workpiece W to move axially in the first direction, and the servo motor 20Z configured to cause the tool 12 or the workpiece W to move axially in the second direction that is perpendicular to the first direction. In addition, the imaging device 24 captures the image of the tool 12 or the workpiece W from a direction that intersects the plane defined by the first direction and the second direction. In accordance with this feature, it is possible for the tool 12 or the workpiece W to be moved axially along a plane. Further, since the imaging device 24 captures images from a direction that intersects the plane defined by the first direction and the second direction, it is possible to suitably capture images of the state of axial movement of the tool 12 or the workpiece W.

The command speeds Vc include the first command speed Vcy in the first direction, and the second command speed Vcz in the second direction. In addition, the speed compensating unit 34 compensates the first command speed Vcy and the second command speed Vcz on the basis of the imaging magnification M, and thereby generates the first compensated command speed Vry and the second compensated command speed Vrz. The motor control unit 36 controls the servo motor 20Y in a manner so that the tool 12 or the workpiece W moves axially in the first direction at the first compensated command speed Vry, and controls the servo motor 20Z in a manner so that the tool 12 or the workpiece W moves axially in the second direction at the second compensated command speed Vrz. Consequently, even in the case that the tool 12 or the workpiece W is moved axially along a plane, it is possible for the tool 12 or the workpiece W to be moved axially at an optimum movement speed in accordance with the imaging magnification M.

In the embodiments described thus far, description has been given that the configuration for causing axial movement of the tool or the workpiece contains the servo motors 20, and the power conversion transmission mechanisms 22 including the ball screws and the nuts. However, in relation to the configuration for causing axial movement of the tool or the workpiece, the ball screws may be replaced with static pressure pneumatic screws.

Similarly, concerning the configuration for causing axial movement of the tool or the workpiece, the servo motors 20 and the power conversion transmission mechanisms 22 including the ball screws and the nuts may be replaced with linear motors (motors).

The present invention is not particularly limited to the embodiment described above, and various modifications are possible without departing from the essence and gist of the present invention.

What is claimed is:

1. A machine tool configured to perform machining on a workpiece using a tool, comprising:
a motor configured to cause axial movement of the tool or the workpiece;
an imaging device configured to capture an image of the tool or the workpiece at a specified imaging magnification;
a display unit configured to display the image captured by the imaging device;
a speed compensating unit configured to compensate a command speed of the tool or the workpiece based on the imaging magnification, and to thereby generate a compensated command speed; and
a motor control unit configured to control the motor in a manner so that the tool or the workpiece is axially moved at the compensated command speed.

2. The machine tool according to claim 1, wherein:
the command speed is a command speed at a time that the imaging magnification is a predetermined reference magnification; and
the speed compensating unit compensates the command speed based on the imaging magnification and the reference magnification.

3. The machine tool according to claim 2, wherein, in a case that the imaging magnification is larger than the reference magnification, the speed compensating unit generates the compensated command speed that is slower than the command speed, and in a case that the imaging magnification is smaller than the reference magnification, the speed compensating unit generates the compensated command speed that is faster than the command speed.

4. The machine tool according to claim 3, wherein the speed compensating unit generates the compensated command speed by multiplying the command speed by a reciprocal of a ratio of the imaging magnification to the reference magnification.

5. The machine tool according to claim 1, wherein:
the command speed is a command speed at a time of axially feeding the tool or the workpiece; and
the motor control unit controls the motor in a manner so that the tool or the workpiece is axially fed at the compensated command speed during a time of axially feeding the tool or the workpiece.

6. The machine tool according to claim 1, wherein:
the tool or the workpiece moves axially along a plane; and
the motor comprises:
a first motor configured to cause the tool or the workpiece to move axially in a first direction; and
a second motor configured to cause the tool or the workpiece to move axially in a second direction perpendicular to the first direction;
wherein the imaging device captures the image of the tool or the workpiece from a direction that intersects the plane defined by the first direction and the second direction.

7. The machine tool according to claim 6, wherein:
the command speed includes a first command speed in the first direction, and a second command speed in the second direction;
the speed compensating unit compensates the first command speed and the second command speed based on the imaging magnification, and thereby generates a first compensated command speed and a second compensated command speed; and
the motor control unit controls the first motor in a manner so that the tool or the workpiece moves axially in the first direction at the first compensated command speed, and controls the second motor in a manner so that the tool or the workpiece moves axially in the second direction at the second compensated command speed.

8. A speed control method for controlling a speed of axial movement of a machine tool configured to perform machining on a workpiece using a tool, wherein:
the machine tool comprises a motor configured to cause axial movement of the tool or the workpiece; and
the speed control method comprises:
an imaging step of capturing an image of the tool or the workpiece at a specified imaging magnification;
a displaying step of displaying the captured image;
a speed compensating step of compensating a command speed of the tool or the workpiece based on the imaging magnification, and thereby generating a compensated command speed; and
a motor controlling step of controlling the motor in a manner so that the tool or the workpiece is axially moved at the compensated command speed.

9. The speed control method according to claim 8, wherein:
the command speed is a command speed at a time that the imaging magnification is a predetermined reference magnification; and
in the speed compensating step, the command speed is compensated based on the imaging magnification and the reference magnification.

10. The speed control method according to claim 9, wherein, in the speed compensating step, in a case that the imaging magnification is larger than the reference magnification, the compensated command speed that is slower than the command speed is generated, and in a case that the imaging magnification is smaller than the reference magnification, the compensated command speed that is faster than the command speed is generated.

11. The speed control method according to claim 10, wherein, in the speed compensating step, the compensated command speed is generated by multiplying the command speed by a reciprocal of a ratio of the imaging magnification to the reference magnification.

12. The speed control method according to claim 8, wherein:
the tool or the workpiece moves axially along a plane; and
the motor comprises:
a first motor configured to cause the tool or the workpiece to move axially in a first direction; and
a second motor configured to cause the tool or the workpiece to move axially in a second direction perpendicular to the first direction;
wherein, in the imaging step, the image of the tool or the workpiece is captured from a direction that intersects the plane defined by the first direction and the second direction.

13. The speed control method according to claim 12, wherein:
the command speed includes a first command speed in the first direction, and a second command speed in the second direction;
in the speed compensating step, the first command speed and the second command speed are compensated based on the imaging magnification, to thereby generate a first compensated command speed and a second compensated command speed; and
in the motor controlling step, the first motor is controlled in a manner so that the tool or the workpiece moves axially in the first direction at the first compensated command speed, and the second motor is controlled in a manner so that the tool or the workpiece moves axially in the second direction at the second compensated command speed.
